(19) United States
(12) Patent Application Publication
(10) Pub. No.: US 2013/0269789 A1
(43) Pub. Date: Oct. 17, 2013

(54) SYSTEM FOR STORING AN ADDITIVE SOLUTION FOR A VEHICLE ENGINE

(71) Applicant: TI AUTOMOTIVE FUEL SYSTEMS SAS, (US)

(72) Inventors: Jean-Sebastien Fromont, Sarry (FR); Stephane Renaut, Jonchery Sur Vesle (FR); Romain Bouvet, Saint Hilaire Le Grand (FR)

(21) Appl. No.: 13/861,167

(22) Filed: Apr. 11, 2013

(30) Foreign Application Priority Data
Apr. 11, 2012 (EP) EP12305424.9

(51) Int. Cl. G05D 23/00

(52) U.S. Cl. CPC G05D 23/00
USPC 137/59

(57) ABSTRACT

A system for storing an additive solution for a vehicle engine, said system comprising a tank for storing said additive solution, a pumping module for pumping said additive solution in the tank and an electrical heating device for heating the additive solution inside the tank when freezing conditions are detected, said electrical heating device being associated with electrical connecting lines for electrical supply of the heating device, wherein the heating device comprises at least an heating module provided in a blind pocket integral with the lower wall of the tank, said pocket opening outside the tank and projecting inside the internal volume of the tank from the lower wall and said electrical connecting lines for electrical supplying of the heating device being fully provided on the outside of the tank.

### REFERENCE TO RELATED APPLICATIONS

This application claims the benefit of EP Application Serial No. 12305424.9 filed Apr. 11, 2012.

### TECHNICAL FIELD

The disclosure relates to an additive tank system for a vehicle exhaust gas handling system.

### BACKGROUND

New legislation that targets the reduction of pollutant emissions from motor vehicles lead to systems for eliminating nitrogen oxides NOₓ from exhaust gases of vehicles. One of the technologies developed, known as SCR for “Selective Catalytic Reduction”, consists in injecting into the exhaust circuit, a solution containing a precursor of ammonia (generally urea) which chemically reduces the NOₓ to nitrogen. The vehicles are therefore provided with an additive tank and a pump for injecting the precursor when needed.

### SUMMARY

A system for storing an additive solution for a vehicle engine includes a tank for storing the additive solution, a pump for pumping the additive in the tank and an electrical heating device for heating the additive solution inside the tank, at least when freezing conditions are detected. The electrical heating device may be associated with electrical connecting lines for electrical supply of the heating device, and the heating device may include a heating module provided in a pocket carried by the tank, such as on or in a lower wall of the tank. The pocket may open outside the tank and project inside the internal volume of the tank, for example from the lower wall, and the electrical connecting lines for electrical supplying of the heating device may be fully provided on the outside of the tank.

According to at least some implementations, the device may comprise a plurality of heating modules, the heating modules may include PTC heaters, and the device may comprise a reserve pot with the pump provided inside the reserve pot and wherein the heating modules cover at least a portion of the wall of the reserve pot.

### BRIEF DESCRIPTION OF THE DRAWINGS

The following detailed description of exemplary embodiments and best mode will be set forth with reference to the accompanying drawings, in which:

FIG. 1 is a perspective view of the outside of one implementation of an additive tank;

FIG. 2 is a perspective view of a lower portion of the tank of FIG. 1;

FIG. 3 is a partial sectional view of the bottom part of the tank;

FIGS. 4 and 5 are fragmentary exploded views of heating modules before insertion in corresponding pockets of the tank;

FIG. 6 is a fragmentary external view of a lower wall of the tank;

FIG. 7 is a graph illustrating the current applied to the heating device and the evolution of temperature respectively at the bottom of a pot in the tank, in the mid height of the pot and outside the pot;

FIG. 8 is a fragmentary, external bottom view of an implementations of an additive tank;

FIG. 9 is a partial sectional and exploded view of the bottom part of the tank;

FIG. 10 is a partial vertical sectional view of the same bottom part of the tank; and

FIG. 11 is another partial sectional view of the bottom part of an implementation of a tank.

### DETAILED DESCRIPTION OF PREFERRED EMBODIMENTS

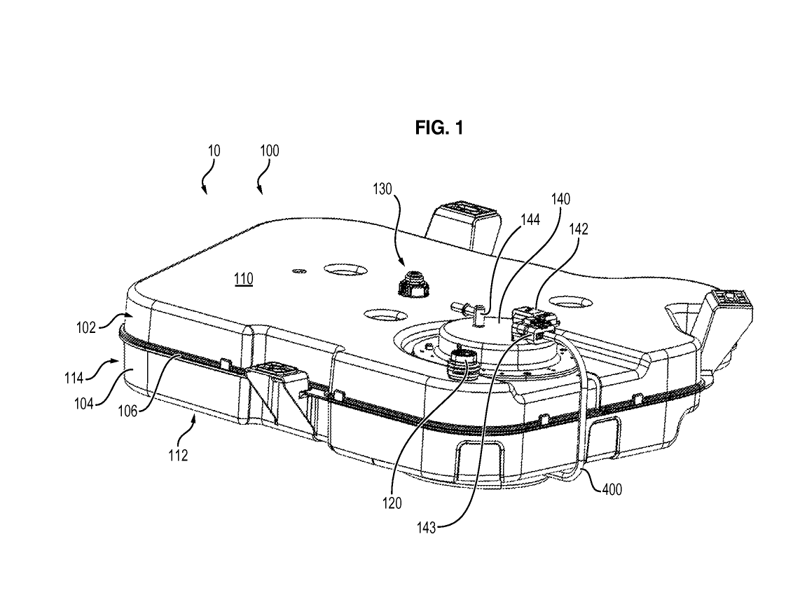

Referring in more detail to the drawings, FIG. 1 illustrates a tank system 10 that includes an additive tank 100, a module 200 for pumping the additive, a heating device 300, and electrical connecting lines 400 for supplying the heating device 300. The tank 100 can be made from a great number of technologies. Preferentially the tank 100 is made from two injection molded half shells, an upper one 102 and a lower one 104, welded or otherwise connected together on their adjacent parts or seam 106. The tank 100, after welding of the two shells 102 and 104, may be considered to have an upper wall 110, a lower wall 112 and a side wall 114 connecting the upper wall 110 and the lower wall 112. In use the upper and the lower walls 110 and 112 are horizontal while the side wall 114 is vertical.

The upper wall 110 may be provided with a filling interface through which liquid is added to the tank 100, and which may include a screw cap 120, a vent 130 and a flange 140 which supports the module 200 for pumping the additive. The filling interface 120 and vent 130 may be of conventional construction and will not be described in detail.

The module 200 for pumping the additive may include a pump 210 located inside the tank 100 and may include the flange 140 that supports the module. The pump 210 for pumping the additive may include any kind of pump compatible with urea. For example, the pump 210 may be formed by an electrically driven rotating pump or a solenoid dosing pump. Such a solenoid dosing pump comprises generally a piston which is moved by a magnetic force issued by the solenoid so as to alternatively draw additive into a pumping chamber and expel the additive outside said pumping chamber.

The flange 140 is provided both with one or more electrical connector(s) 142 for electrically supplying the pump 210 and one or more hydraulic connection(s) 144 in connection with the output of the pump. More precisely the pump 210 may be located inside a reserve pot 160 that may be formed integral with and in the lower wall 112 of the tank. Thus the pump 210 is vertically integrated in the tank in this implementation, although other orientations may be utilized. The coil or solenoid of the pump 210 (when a solenoid pump is used) may be used as an additional heating device for cavitation prevention. The flange 140 may also integrate an electronic dosing module suitable for controlling the operation of the solenoid dosing pump 210.

According to the specific embodiment illustrated on the enclosed figures, the pot 160 is made by a generally cylindrical wall 161 so that the horizontal cross section of the pot 160 is about circular. The inside volume of the pot 160 is in communication with the volume of the tank 100 outside the pot 160 by any controlling means suitable for allowing free filling up of the pot 160 from the tank (i.e. free transfer of additive from the tank 100 towards inside the pot 160), while limiting draining of the pot 160 (i.e. limiting transfer of additive form inside the pot 160 towards the tank 100). For example such controlling means may be a cylindrical labyrinth 162 integral with the wall 161 and in connection on a one side with the inside volume of the pot 160 and in connection on the other side with the volume of the tank outside said pot 160.

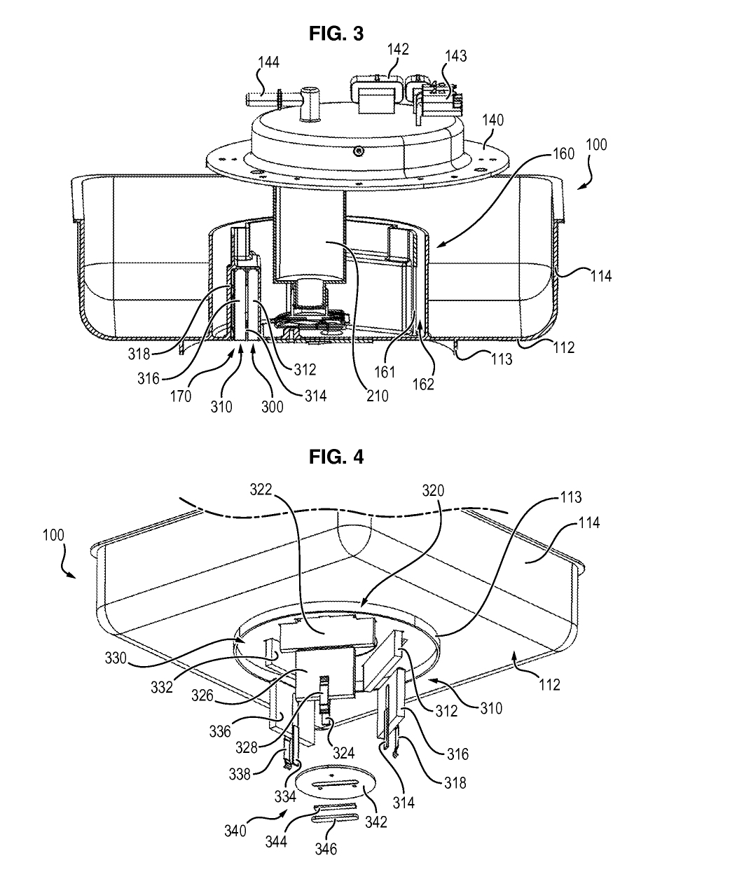

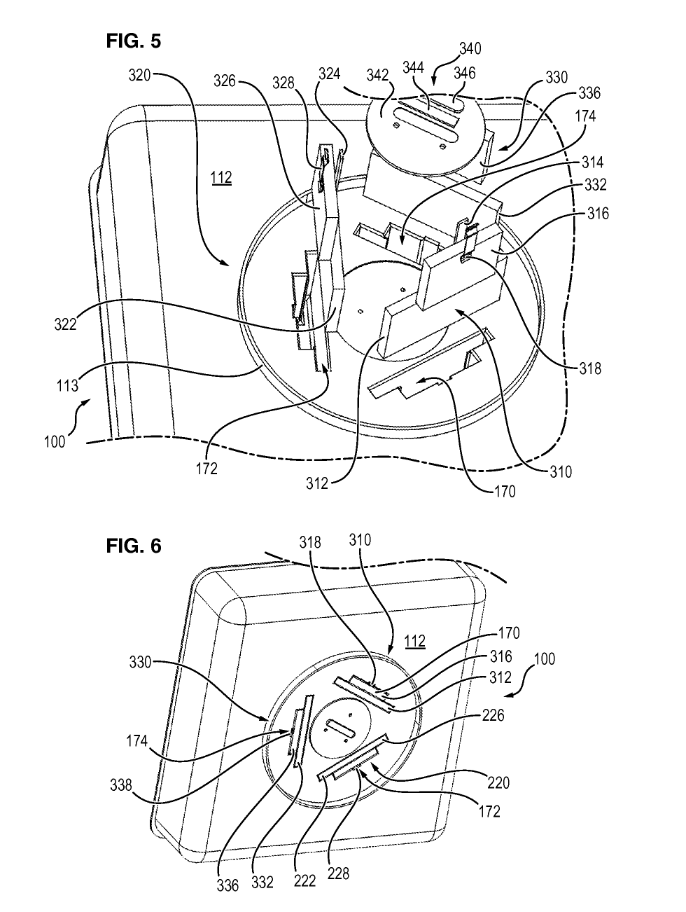

The first embodiment illustrated on FIGS. 3 to 6 will be first described. This embodiment is intended to be representative of at least certain concepts but is not intended to limit the scope of the disclosure.

As indicated above, the heating device 300 may include at least a heating module 310 provided in a blind pocket 170 carried by or integral with (i.e. integrally formed in) the lower wall 112 of the tank 100. In this implementations, the pocket 170 projects inside the internal volume of the tank 100 from the lower wall of the tank as illustrated on FIG. 3 and opens outside the tank on the bottom side of the tank. The heating device 300 may be placed inside blind pockets which do not open inside the tank 300, so that the heating device is fully isolated from urea and consequently there is no risk of corrosion of the heating device 300 by the urea and no specific anti-corrosion sheathing is needed. Instead of being formed in the lower wall, the blind pocket may be provided in another structure sealed to or otherwise carried by the lower wall, for example, on a flange that supports the pump and is coupled to the bottom wall of the tank, as opposed to (or in addition to) the upper wall. In addition, the pocket may project toward or near the bottom wall of the tank from, for example, the upper wall 110 or side wall 114 of the tank.

The heating device 300, in at least certain implementations, may include a plurality of heating modules 310, 320, 330 and 340 dispatched on the lower wall 112 of the tank so as to generally cover the wall 161 of the pot 160. According to the specific embodiment illustrated on the enclosed figures, the heating device 300 comprises a plurality of heating modules (310, 320, 330) regularly angularly dispatched around the lateral wall 161 of the pot 160 and one or more additional heating modules 340 provided on the outside surface of the bottom wall of the pot 160. More precisely according to the specific embodiment illustrated on the enclosed FIGS. 3 to 6, the heating device 300 comprises 3 heating modules 310, 320, 330 angularly dispatched around the wall 161 of the pot 160 and an additional heating module 340 provided on the outside surface of the bottom wall of the pot 160.

The heating modules 310, 320 and 330 are provided in respective blind pockets 170, 172, 174 that may be integral with the wall 161 of the pot 160 (see FIG. 3). Said pockets 170, 172, 174 project inside the tank 100 from the bottom wall 112. Each pocket defines a generally parallelepiped internal chamber receiving a heating module 310, 320 or 330.

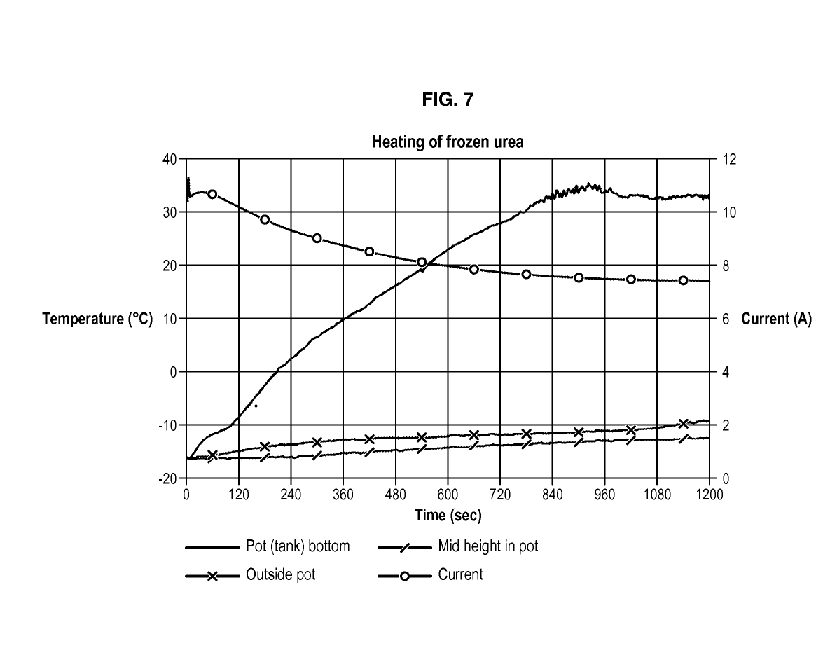

In one form, the heating modules 310, 320, 330 and 340 comprise Positive Temperature Coefficient (PTC) heaters 314, 324, 334 and 344. PTC heating means are well-known. PTC heating elements may be made from ceramic, such as ceramic based on barium titanate. When a voltage is placed across a PTC, current will flow and begin to heat the PTC. Initially, the resistance drops, allowing more current to flow and thus begins to heat more quickly. PTC heaters are effective low cost solutions providing highly efficient source of heat in a very small enclosure. FIG. 7 illustrates one representative heating arrangement which shows the temperature of a mid height of the pot, the pot bottom and an area outside the pot, over time. The chart shows, among other things, that the pot bottom heats very quickly to facilitate melting urea near the bottom of the tank and the inlet of the pump 210.

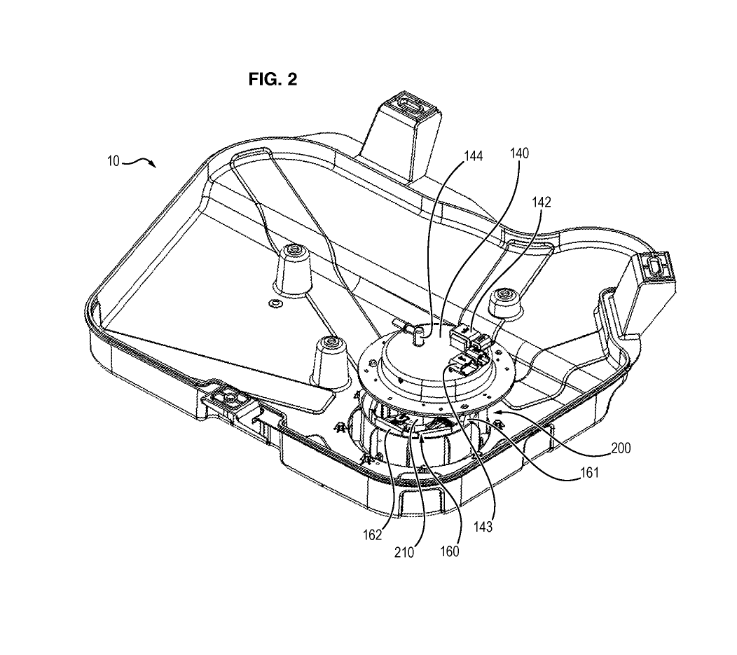

As illustrated on the enclosed FIGS. 2 to 6 the PTC heaters 314, 324, 334 and 344 may each be provided between two metal electrodes 312, 316; 322, 326; 332, 336; 342, 346, such as aluminum or copper electrodes. One of said electrodes 312, 322; 332 is directly in contact with the outside surface of the wall 161 of the pot 160. The electrode 342 is in contact with the outside surface of the bottom wall of the pot 160. A resilient spring 318, 328, 338, is provided between the other electrode 316, 326 336 and the internal surface of the receiving pocket so as to exert a pressure upon the stacks of electrodes and PTC heaters.

The electrodes 312, 316; 322, 326; 332, 336 may generally have a parallelepiped shape. The electrodes 342, 346 are generally circular although other shapes may be used. As illustrated on the enclosed figures, electrodes 312, 316; 322, 326; 332, 336; 342, 346 have a cross section larger than the PTC heaters 314, 324, 334 and 344.

A cover may be fixed on a circular rib 113 that may be formed integral with the lower surface of the lower wall 112, after electrical connection of the heating modules 300 so as to protect the heating device 300. Such a cover is not illustrated on the enclosed figures. A spring similar to the springs 318, 328, 338 may be inserted between the PTC heater 344 and the cover.

Moreover, as indicated above, the electrical connecting lines 400 for electrical supplying of the heating device 300 are, in at least some implementations, fully provided on the outside of the tank 100 so that they are not exposed to the urea within the tank. Such connecting lines 400 extend from a connector 142 provided on the flange 140 and each one of the PTC modules 310, 320, 330 and 340. Said connecting lines 400 being placed outside the tank 300, they are fully isolated from urea and consequently there is no risk of corrosion of said connecting lines 400 by the urea, without needing any specific anti-corrosion sheathing.

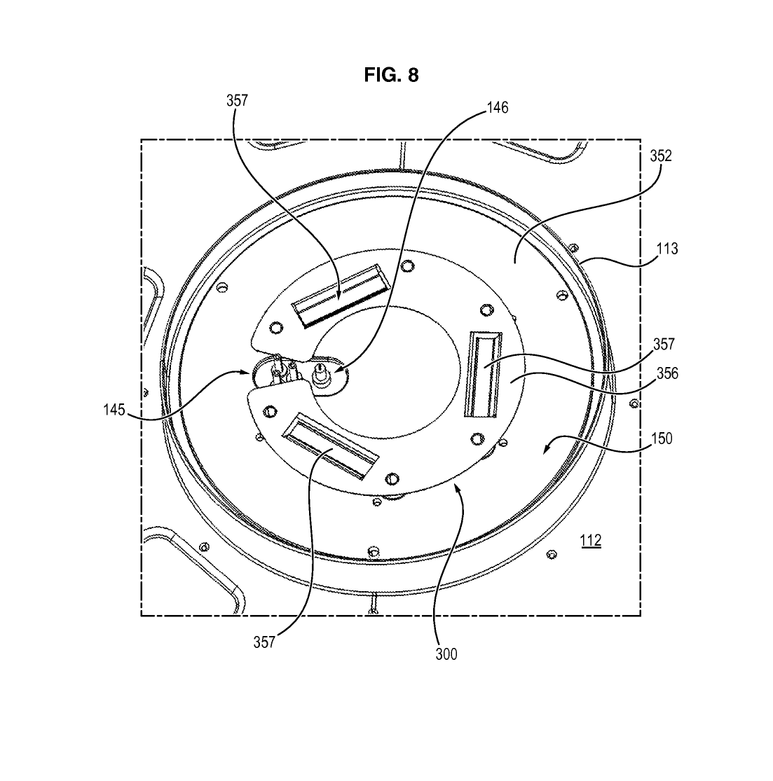

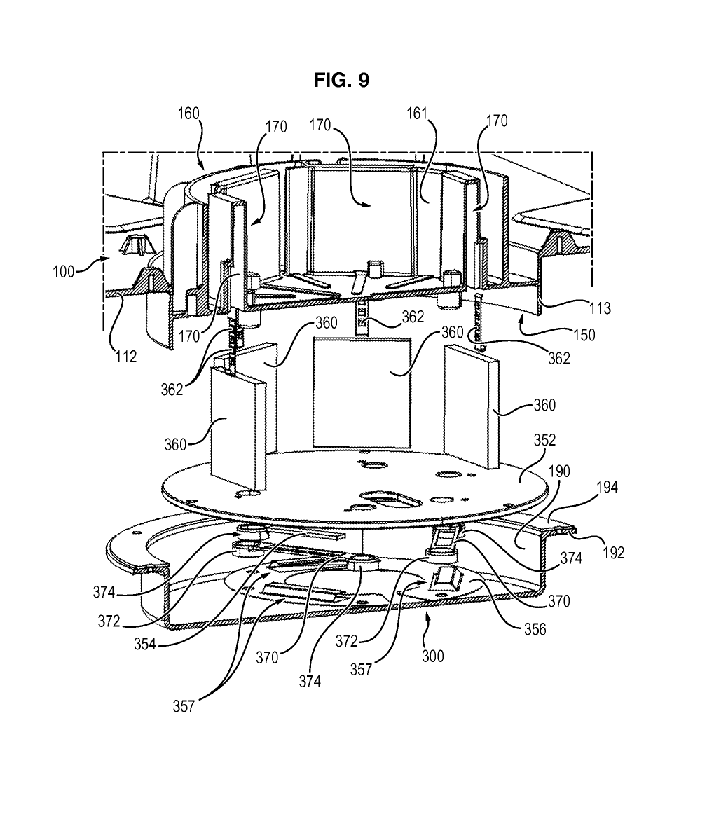

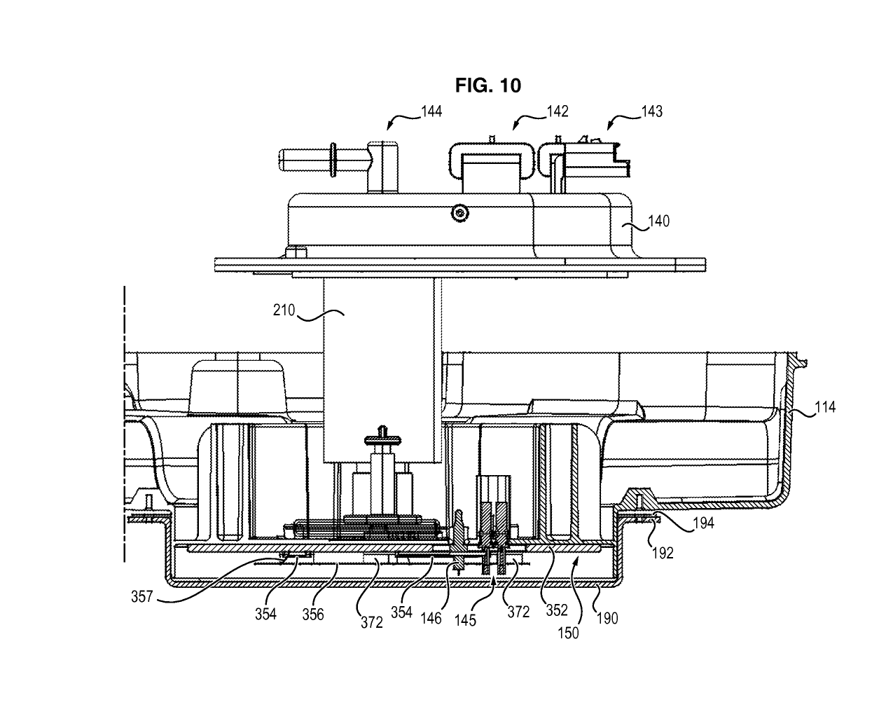

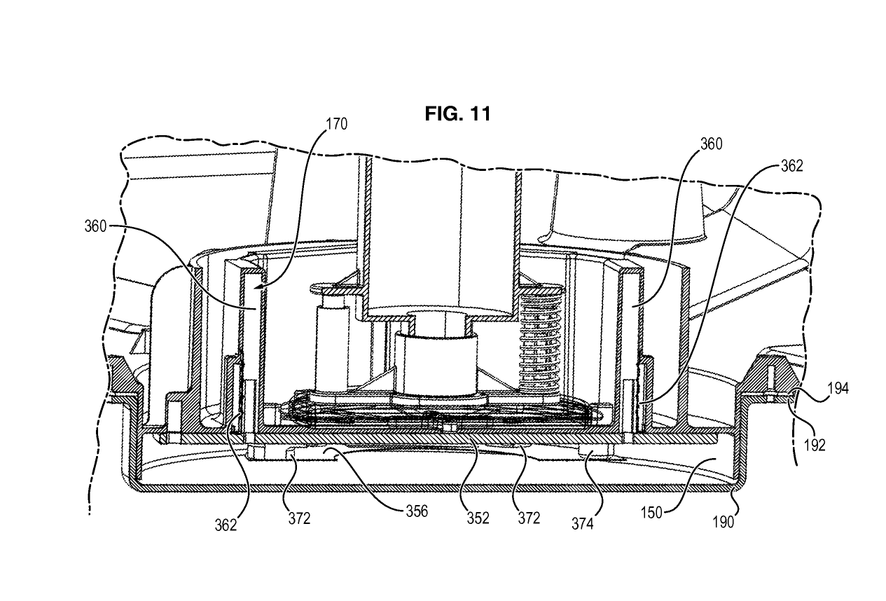

The second embodiment illustrated in FIGS. 8 to 11 will be now described. According to the second embodiment illustrated on FIGS. 8 to 11, the heater device 300 is provided in a bottom chamber 150 formed on or near the external surface of the lower wall 112, as well as in a plurality of blind pockets 170 in communication with said chamber 150, and provided around the wall 161 of the pot 160. The chamber 150 is preferentially inside a circular rib 113 integral with the lower surface of the lower wall 112 and a cover 190. An annular seal 194 is provided between a collar 192 of the cover 190 and the lower wall 112 of the tank 100.

The heater device 300 in this implementation comprises a plurality of PTC heaters 354, such as 3 PTC heaters 354, provided inside the chamber 150 between a bottom contact plate 356 and an heater plate 352. The heater plate 352 is adjacent the lower wall 112. In at least some forms, the heater plate 352 has a circular shape and is made from aluminum or copper or other suitably thermally conductive material.

The contact plate 356 is adjacent the cover 190. The contact plate 356 may be a ring including stamped parts 357 forming an elastic or biasing mechanism(s) which urges the PTC heaters 354 and the heater plate 352 against the lower surface of the lower wall 112 so as to optimize the heat transfer from the heater plate 352 to the lower wall 112. Contact plate 356 and parallel heater plate 352 are electrodes for electrical supplying of the PTC heaters 354 from the connecting lines 400.

Moreover the heater device illustrated in FIGS. 8 to 11 includes heat sinks 360 linked with the heater plate 352 and inserted in the pockets 170 provided around the wall 161 of the pot 160. The heat sinks 360 may be made from parallelepiped blocks connected by any means, such as screwing or welding, to the heater plate 352. The heat sinks 360 extend vertically and transversely to the horizontal heater plate 352. The heat sinks 360 are provided in the pockets around the wall 161 of the pot 160 so as to cover as far as possible a majority of the surface of the wall 161. The heat sinks 360 may be urged against the outside surface of the wall 161 of the pot 160 by respective resilient springs 362 inserted in the pockets 170.

According to a specific and not limiting embodiment, the heater device comprises 6 pockets 170 regularly spaced around the wall 161 of the pot 160 and 6 heat sinks 360 with 6 springs 362 inserted respectively in each of said pockets 170. According to the embodiment illustrated on FIGS. 8 to 11, preferentially each PTC heater 354 is provided in a cradle 370 linked to two respective spacers 372, 374.

The spacers 372, 374 define the distance between the contact plate 356 and the heater plate 352. The cradle 370 is suitable to authorize a displacement of the PTC heaters 354 transversely to the contact plate 356 so as to warrant contact between said PTC heaters 354 and the heater plate 352. The spacers 372, 374 are preferentially made from thermoplastic material so as to form an electric insulation between the contact plate 356 and the heater plate 352.

Preferentially the contact plate 356 is an open ring so as to clear a zone wherein is implemented a level sensor 145 and a temperature sensor 146.

The system provides an additive tank wherein no metallic part of the heating devices, neither the heating elements themselves nor the electrical wires for the heating elements, is inside the tank. This provides a high level of robustness and low risk of failure which may otherwise occur due to corrosion. The system may be cost effective, such as by using aluminum simple shapes instead of either stainless steel parts or overmolded aluminum heater. Further, with the heating device components not located within the tank, assembly of the heating devices is simplified. Very good thermal conduction to the tank may be easily achieved with aluminum or other materials of suitable thermal conductivity. Further, the heather may be self thermally regulated by use of, for example, PTC heating elements. With the components outside of the tank and not corroding within the tank, there is no risk of altering the urea quality. Optimization of the blind pockets using an injection molded tank enables automatic optimized shapes for the insertion of heater components, without needing any kind of additional machining

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A system for storing an additive solution, comprising:
a tank for storing said additive solution;
a pump for pumping said additive solution in the tank; and
a heating device for heating the additive solution inside the tank at least when freezing conditions are detected, said electrical heating device being associated with electrical connecting lines for electrical supply of the heating device, wherein the heating device comprises at least a heating module provided in a blind pocket carried by the lower wall of the tank, said pocket opening outside the tank and projecting inside the internal volume of the tank and said electrical connecting lines for electrical supplying of the heating device being fully provided on the outside of the tank.

2. The system according to claim 1, wherein the device comprises a plurality of heating modules each including a PTC heater.

3. The system according to claim 1, wherein the device comprises a reserve pot, the pump is provided inside the reserve pot and the heating modules cover at least the majority of the wall of the reserve pot.

4. The system according to claim 1, wherein the device comprises a reserve pot having a generally circular wall vertical on the lower wall of the tank, the pump being provided inside the reserve pot, a plurality of heating modules covering at least the majority of the circular wall of the reserve pot and an additional heating module provided on the lower wall of the reserve pot.

5. The system according to claim 1, wherein the heater device is provided in a bottom chamber formed on the external surface of the lower wall of the tank, as well as in a plurality of blind pockets in communication with said chamber, provided around the wall of a reserve pot, the heater device comprising a plurality of PTC heaters provided inside said chamber between a bottom contact plate and a heater plate and heat sinks linked with the heater plate and inserted in the pockets provided around the wall of the pot.

6. The system according to claim 5, wherein the heater plate is adjacent the lower wall of the tank.

7. The system according to claim 5, wherein the contact plate is provided with a biasing mechanism that urges the PTC heaters and the heater plate against the lower surface of the lower wall of the tank.

8. The system according to claim 5, wherein the heat sinks are urged against the outside surface of the wall of the pot by respective resilient springs inserted in the pockets.

9. The system according to claim 5, wherein each PTC heater is provided in a cradle.

10. The system according to claim 5, wherein spacers are provided between the contact plate and the heater plate.

11. The system according to claim 1, wherein each heating module comprises a PTC heater provided between two metal electrodes.

12. The system according to claim 11, wherein the metal electrodes are made in aluminum or copper.

13. The system according to claim 1, wherein each heating module comprises a resilient spring provided between an electrode and the internal surface of a receiving pocket so as to exert a pressure upon a stack of electrodes and a heater.

14. The system according to claim 1, wherein said electrical connecting lines for electrical supplying of the heating device extend from a connector provided on a flange supported on the upper wall of the tank and each heating module.

15. The system according to claim 1, wherein the device comprises a reserve pot and each blind pocket is integral with a vertical wall of the pot.

16. A system for storing an additive solution, comprising:
a tank for storing said additive solution;
a pump for pumping said additive solution in the tank; and
a heating device for heating the additive solution inside the tank at least when freezing conditions are detected, said electrical heating device being associated with electrical connecting lines for electrical supply of the heating device, wherein the heating device comprises at least a heating module provided in a blind pocket carried by the tank, said pocket opening outside the tank and projecting inside the internal volume of the tank and said electrical connecting lines for electrical supplying of the heating device being fully provided on the outside of the tank.
